(19) United States
(12) Patent Application Publication
(10) Pub. No.: US 2007/0112118 A1
(43) Pub. Date: May 17, 2007

(54) Organic-inorganic hybrid photopolymer composition with enhanced diffraction efficiency and decrease volume reduction

(75) Inventors: Jung-Ki Park, Daejeon (KR); Won-Sun Kim, Daejeon (KR); Yong-Cheol Jeong, Daejeon (KR); Hyun-Dae Hah, Daejeon (KR)

Correspondence Address: STERNE, KESSLER, GOLDSTEIN & FOX P.L.L.C., 1100 NEW YORK AVENUE, N.W., WASHINGTON, DC, 20005, US

(73) Assignee: Korea Advanced Institute of Science and Technology, Daejeon (KR)

(21) Appl. No.: 11/495,880

(22) Filed: Jul. 31, 2006

(30) Foreign Application Priority Data
Jul. 29, 2005 (KR) 10-2005-0069852

(51) Int. Cl. B60C 1/00

(52) U.S. Cl. 524/492; 524/497

(57) ABSTRACT

The present invention relates to an organic-inorganic hybrid composition comprising: (a) a copolymer matrix having an organic functional group; (b) an inorganic nanoparticle having an inorganic functional group on the surface of the nanoparticle; (c) a photopolymerizable monomer; (d) a photoinitiator, and (e) a photosensitizer.

This application claims priority to Korean Patent Application No. 10-2005-0069852, filed Jul. 29, 2005, which is incorporated by reference herein in its entirety.

### BACKGROUND OF THE INVENTION

1. Field of the Invention

The present invention relates to an organic-inorganic hybrid composition comprising: (a) a copolymer matrix having an organic functional group; (b) an inorganic nanoparticle having an inorganic functional group on the surface of the nanoparticle; (c) a photopolymerizable monomer; (d) a photoinitiator, and (e) a photosensitizer.

2. Related Art

In accordance with rapid growth of the 21^{st}-century informational society, there is an urgent need to develop materials capable of displaying, transmitting and storing large amounts of information. Recent research has focused on developing materials for displaying, transmitting and storing information using light.

Use of optical communications for high-speed transmission of large amounts of information has been investigated, but three-dimensional information storage devices have not previously been realized because suitable materials have not been developed. Materials capable of photoisomerization, materials having photo refractivity, and photopolymers have been investigated for use in storing three-dimensional information using light.

Photopolymers generally contain a photopolymerizable monomer, a photoinitiator and a polymer binder. Photopolymerization begins when constructive interference occurs by photopolymerization due to interference of light to increase intensity of the photopolymerized polymer. Photopolymerization does not occur where destructive interference occurs to form a region with a high density of polymer binder.

Since a photopolymer forms a grid by photopolymerization, it can be used as a three-dimensional information storage material in a Read-only-Memory (ROM) and is advantageous for forming an in-situ diffraction grid upon interference of two lights. The refractive index of a photopolymer varies according to the kinds of polymer matrix and photopolymerized monomer used, therefore it is possible to design an organic material having enhanced diffraction efficiency at low cost. However, photopolymers similar to the present invention have not previously been used because of problems with volume reduction (shrinkage) due to photopolymerization upon recording a grid. In order to reduce photopolymer volume from shrinking, it was suggested that a glass having a nano-sized stomate be used, or a photopolymer with an increased matrix rigidity formed by scattering inorganic particles be used. However, in cases wherein inorganic particles are scattered, loss due to light scattering reaches a very high level of 20% and reaction delay time is approximately 10 seconds. Thus, the reaction speed becomes very low.

Suzuki et al. (Appl. Phys. Let., 81:4121 (2002)) reports simply scattering TiO₂ nanoparticles into a methacrylate series monomer, and the monomers and nanoparticles are moved reversly by irradiating interference patterns of light to manufacture a nanocomposite photopolymer forming a grid. However, the loss of light scattering and a slow reaction speed continue to be a problem.

### BRIEF DESCRIPTION OF THE DRAWINGS

FIG. 1 shows a change in diffraction efficiency by beam research time. The filled squares (a) show a photopolymer containing nanoparticles at a concentration of 1.25 wt %, and the filled circles (b) show a photopolymer which does not contain nanoparticles.

FIG. 2 shows kinds of nanoparticles and diffraction efficiency classified by contents. The filled circles (a) show a photopolymer containing polar nanoparticles, and the filled squares (b) show non-polar particles with 66% carbon contents.

### SUMMARY OF THE INVENTION

The present invention is directed to an organic-inorganic hybrid composition comprising: (a) a copolymer matrix having an organic functional group; (b) an inorganic nanoparticle having an inorganic functional group on the surface of the nanoparticle; (c) a photopolymerizable monomer; (d) a photoinitiator, and (e) a photosensitizer.

In some embodiments, the organic-inorganic hybrid photopolymer composition comprises a copolymer matrix comprising a polymethylmethacrylate copolymer in a concentration of 50˜75 wt %, a photopolymerizable monomer acrylamide in a concentration of 15˜35 wt %, a hydrophilic inorganic silica nanoparticles in a concentration of 0.5˜3 wt %, a photoinitiator in a concentration of 5˜25 wt %, and a photosensitizer in a concentration of 0.02˜0.06 wt %.

In some embodiments, the organic functional group is selected from the group consisting of: a polyalkylacrylate, a polystyrene, a polyvinyl alcohol, a polyvinyl carbarzole, a polycellulose, a polyurethane, a polyvinyl acetate, an ethylene/vinyl acetate, a vinylidene chloride, a synthetic rubber, a polyethylene imine, a polyepoxide and a polycarbonate.

In some embodiments, the organic functional group is selected from a sulfonic acid, an acrylic/methacrylic acid, an amide, a pyrrolidone, and ethylene glycol organic functional group.

In some embodiments, the inorganic nanoparticle having an inorganic functional group on the surface of the nanoparticle is selected from a group consisting of silica, titanium dioxide, zirconia, aluminum oxide, magnesium oxide, magnesium hydroxide and antimony pentoxide. In some embodiments, the inorganic nanoparticle is silica or titanium dioxide

In some embodiments, the photopolymerizable monomer is selected from acrylamide, bisacrylamide, t-butylacrylamide, vinyl carbazole, alkyl acrylate, multifunctional alkyl acrylate, a benzyl acrylate, a multifunctional benzyl acrylate series, stylene, acrylonitrile, vinyl imidazole, vinyl cycloprophane, and combinations thereof.

In some embodiments, the photoinitiator is selected from triethanolamine, butyle amine, triethylamine, N-phenylglycine, sulfinates, enolates, carboxylates, p-toluene sodium salt, acetylacetone, t-butyl hydrogen peroxide, ferric ammonium citrate, hexaarylbiimidazole, aromatic carbonyl compound, ketone derivatives and quinone derivatives.

In some embodiments, the photosensitizer is selected from methylene blue, yellowiosine, tionin, Rose Bengal, Erythrosin B and acryflavine.

In some embodiments, the nanoparticles have a diameter of about 10 nm to about 70 nm.

In some embodiments, the invention is directed to a method of making a organic-inorganic hybrid photopolymer comprising (a) mixing a polymethylmethacrylate copolymer matrix, an acrylamide photopolymerizable monomer, a hydrophilic inorganic silica nanoparticle, an initiator, and a sensitizer to form a mixture, and (b) polymerizing the mixture.

### DETAILED DESCRIPTION OF THE INVENTION

The present invention is directed to an organic-inorganic hybrid composition comprising: (a) a copolymer matrix having an organic functional group; (b) an inorganic nanoparticle having an inorganic functional group on the surface of the nanoparticle; (c) a photopolymerizable monomer; (d) a photoinitiator, and (e) a photo sensitizer.

In some embodiments, the invention is directed to an organic-inorganic hybrid photopolymer comprising a polymethylmethacrylate copolymer matrix, a hydrophilic inorganic silica nanoparticle, an acrylamide photopolymerizable monomer, a photoinitiator, and a photosensitizer. In some embodiments, a small amount of hydrophilic inorganic silica nanoparticles are scattered in the photopolymer composition to induce hydrogen bonding between hydroxyl groups on the surface of the nanoparticles and the other photopolymer components. In some embodiments, the addition of nanopoarticles induces a non-linear refractive index modulation due to a change of a polarizability. In some embodiments, the invention provides an organic-inorganic hybrid photopolymer composition having enhanced diffraction efficiency and decreased volume reduction.

The present invention is also directed to a method of decreasing volume reduction in an organic-inorganic hybrid photopolymer composition by introducing hydrophilic silica nanoparticles to the organic-inorganic hybrid composition. This increases matrix rigidity and at the same time induces hydrogen bonding at the interface between a hydroxyl group of the nanoparticle surface and the photopolymer components to provide an organic-inorganic hybrid copolymer capable of increasing diffraction efficiency and recording speed.

In some embodiments, the present invention provides a new photopolymer which has high diffraction efficiency due to a non-linear refractive index modulation caused by a change of a polarization at an interface, without causing a loss due to light scattering and wherein the volume reduction is refrained without decreasing recording speed.

In some embodiments, the functional group is selected from the group consisting of a polyalkylacrylate, a polystyrene, a polyvinyl alcohol, a polyvinyl carbarzole, a cellulose (e.g., cellulose acetate, cellulose acetate butylate, methyl/ethyl/benzyl cellulose), a polyurethane, a polyvinyl acetate, an ethylene/vinyl acetate, a vinylidene chloride (e.g., vinlylidene chloride/acrylonitrile, vinylidene chloride/vinyl acetate), a synthetic rubber (e.g., butadiene/acrylonitrile copolymer, acrylonitrile/butadiene/styrene copolymer, methacrylate/acrylonitrile/butadiene/styrene copolymer, styrene/butadiene/styrene block copolymer, styrene/isoprene/styrene block copolymer, etc.), a polyethylene imine, a polyepoxide, and a polycarbonate.

A nanoparticle with an inorganic functional group on the surface of the nanoparticle includes nanoparticles selected from silica (SiO₂) or titanium dioxide (TiO₂). An organic functional group with a polarity on the surface includes nanoparticles bonded by one selected from a sulfonic acid series, an acrylic/methacrylic acid series, an amide series, a pyrrolidone series or ethylene glycol series organic functional group. In some embodiments, the functional group is a nanoparticle with a positive ionizer, e.g., Li⁺, Na⁺, K⁺, Ca²⁺, etc.

An inorganic nanoparticles having an inorganic functional group on the surface of the nanoparticle is selected from the group consisting of silica, titanium dioxide, zirconia, aluminum oxide, magnesium oxide, magnesium hydroxide and antimony pentoxide. In some embodiments, the inorganic nanoparticle is silica or titanium dioxide.

In some embodiments, the above inorganic and organic functional groups can use nanoparticles with a size of about 10 nm to about 70 nm.

In the present invention, a polymerizable monomer can be any monomer capable of being polymerized by light. In some embodiments, the photopolymerizable monomer is selected from acrylamide, bisacrylamide, t-butylacrylamide, vinyl carbazole, alkyl acrylate, multifunctional alkyl acrylate, a benzyl acrylate, a multifunctional benzyl acrylate series, stylene, acrylonitrile, vinyl imidazole, vinyl cycloprophane, and combinations thereof.

In some embodiments, a photopolymerization-causing initiator is an electron donor and is selected from triethanolamine, butyle amine, trimetylamine, N-phenylglycine, sulfinates, enolates, carboxylates, p-toluene sodium salt, acetylacetone, t-butyl hydrogen peroxide, ferric ammonium citrate, hexaarylbiimidazole, aromatic carbonyl compound (e.g., benzoin ether, ketal, acetophenone or acryl phosphine oxide), ketone derivates or quinone derivatives.

In some embodiments, the photosensitizer is an electron acceptor and is selected from methylene blue, yellowiosine, tionin, Rose Bengal, Erythrosin B or acrylflavine.

In some embodiments, the photopolymer composition according to the present invention can include a polymethylmethacrylate copolymer matrix (directly composed at a level of molecular weight of 50,000, metylmethacrylate is used as a basis, and 5%˜20% methacrylic acid is copolymerized as a polymerizable monomer) at a concentration of 50˜75 wt %, a acrylamide photopolymerizable monomer (Sigma Aldrich) at a concentration of 15˜35 wt %, a hydrophilic inorganic silica nanoparticles (Aerosil 200, Degussa) at a concentration of 0.5˜3 wt %, an initiator (Triethanolamine, Sigma Aldrich) at a concentration of 5˜25 wt % and a sensitizer (Methylene blue, Sigma Aldrich) at a concentration of 0.02˜0.06 wt % to provide an organic-inorganic hybrid photopolymer.

The present invention now will be exemplified in the following examples.

### EXAMPLE 1

A photopolymer composition was made which included a copolymer matrix of polymethylmethacrylate in a concentration of 51 wt %, a photopolymerizable monomer of acrylamide in a concentration of 23.75 wt %, a hydrophilic inorganic nanoparticle of silica in a concentration of 1.25 wt %, and a mixture of an initiator and a sensitizer in a concentration of 24 wt % (Triethanolamine 23.94 wt %+Methylene blue 0.06 wt %) to provide an organic-inorganic hybrid photopolymer.

The photopolymer obtained by the above composition was transmitted through a laser at a wavelength of 633 nm, and the intensity of light transmitted through the photopolymer and optical transmittance was measured. Results are shown in the Table 1.

### EXAMPLE 2

A photopolymer composition was made which included a copolymer matrix of polymethylmethacrylate in a concentration of 51 wt %, a photopolymerizable monomer of acrylamide in a concentration of 25 wt %, and a mixture of initiator and a sensitizer in a concentration of 24 wt % (Triethanolamine 23.94 wt %+Methylene blue 0.06 wt %) to provide a photopolymer which did not include silica nanoparticles. Optical transmittance was measured as in Example 1. Results are shown in the Table 1.

### EXAMPLE 3

A photopolymer composition was made which included a copolymer matrix of polymethylmethacrylate in a concentration of 51 wt %, a photopolymerizable monomer of acrylamide in a concentration of 23.75 wt %, and a mixture of initiator and a sensitizer in a concentration of 24 wt % (Triethanolamine 23.94 wt %+Methylene blue 0.06 wt %). Hydrophobic silica at a concentration of 1.25 wt % was scattered to the surface of which 66% was carbonized to form a photopolymer. Optical transmittance was measured as described in Example 1. Results are shown in Table 1.

TABLE 1
Photopolymer Compositions of Examples 1-3

| Classification | Thickness | Transmittance | Remarks |
|---|---|---|---|
| Example 1 | 130 μm | 91% | Hydrophilic silica |
| | | | contained |
| Example 2 | 136 μm | 92% | No silica |
| Example 3 | 130 μm | 91% | Hydrophobic silica |
| | | | contained |

### EXAMPLE 4

The recording characteristics of a grid of a photopolymer manufactured according to Example 1 was investigated. A laser beam with a wavelength of 633 nm was interfered to obtain a change in diffraction efficiency according to an exposure time in the table 1.

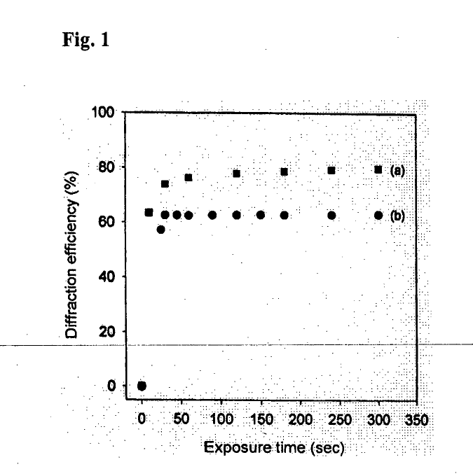

FIG. 1 shows a change in a diffraction efficiency by a beam research time. A photopolymer including 1.25% nanoparticles (Example 1) is represented by filled squares (a). A photopolymer not including nanoparticles (Example 2) is represented by filled circles (b).

### EXAMPLE 5

In order to estimate a diffraction efficiency of a photopolymer manufactured in the Example 2, diffraction efficiency at a given time is measured in the same method as in Example 4. Results are shown in FIG. 1, and the maximum diffraction efficiency and sensitivity are shown in Table 2.

TABLE 2
Diffraction efficiency and sensitivity according to Examples 1-3

| | Diffraction | | |
|---|---|---|---|
| Classification | efficiency | Sensitivity | Remarks |
| Example 1 | 80% | 60 mJ/cm² | Hydrophilic silica |
| | | | contained |
| Example 2 | 65% | 105 mJ/cm² | No silica |
| Example 3 | 40% | 75 mJ/cm² | Hydrophobic silica |
| | | | contained |

### EXAMPLE 6

To confirm diffraction efficiency improvement of a hydrophilic silica, a change in diffraction efficiency according to the silica content with respect to Examples 1 and 3 are shown in Table 2.

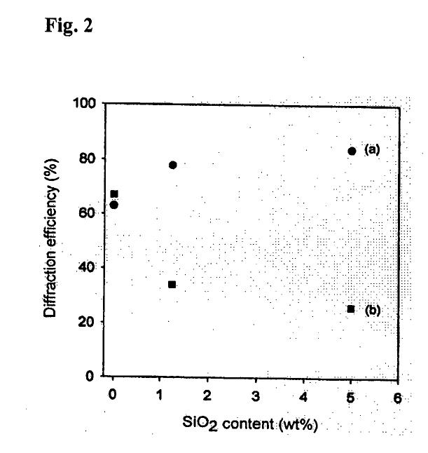

FIG. 2 shows kinds of nanoparticles and diffraction efficiency classified by contents. Photopolymers including polar nanoparticles (Example 1) are represented by filled circles, and non-polar particles with 66% carbon contents (Example 2) are represented by filled squares.

### EXAMPLE 7

To investigate volume reduction of a photopolymer manufactured as described in Examples 1-3, changes in a density were recorded as shown in the Table 3.

TABLE 3
Density changes in accordance with Examples 1-3.

| Classification | Density | Volume shrinkage | Remarks |
|---|---|---|---|
| Example 1 | 0.07% | 5.5% | Hydrophilic silica |
| | | | contained |
| Example 2 | 0.08% | 7.0% | No silica |
| Example 3 | 0.076% | 6.2% | Hydrophobic silica |
| | | | contained |

The present invention provides a new photopolymer which does not lead to loss of a light scattering and has an enhanced diffraction efficiency by non-linear diffraction rate modulation due to a change of polarization at an interface and of which volume reduction is minimized without decreasing recording speed. The organic-inorganic hybrid photopolymer manufactured in accordance with the present invention has excellent phase stability, diffraction efficiency and decreased volume reduction. Therefore, the photopolymer can be used as a large-volumed optical information storage medium.

These examples illustrate possible embodiments of the present invention. While the invention has been particularly shown and described with reference to some embodiments thereof, it will be understood by those skilled in the art that they have been presented by way of example only, and not limitation, and various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. An organic-inorganic hybrid composition comprising: (a) a copolymer matrix comprising an organic functional group; (b) an inorganic nanoparticle comprising an inorganic functional group on the surface of the nanoparticle; (c) a photopolymerizable monomer; (d) a photoinitiator, and (e) a photo sensitizer.

2. An organic-inorganic hybrid photopolymer composition comprising a copolymer matrix comprising a polymethylmethacrylate copolymer in a concentration of 50˜75 wt %, a photopolymerizable monomer acrylamide in a concentration of 15˜35 wt %, a hydrophilic inorganic silica nanoparticles in a concentration of 0.5˜3 wt %, a photoinitiator in a concentration of 5˜25 wt %, and a photosensitizer in a concentration of 0.02˜0.06 wt %.

3. The organic-inorganic hybrid photopolymer composition of claim 1, wherein the copolymer matrix comprising an organic functional group is selected from the group consisting of: a polyalkylacrylate, a polystyrene, a polyvinyl alcohol, a polyvinyl carbarzole, a polycellulose, a polyurethane, a polyvinyl acetate, an ethylene/vinyl acetate, a vinylidene chloride, a synthetic rubber, a polyethylene imine, a polyepoxide and a polycarbonate.

4. The organic-inorganic hybrid photopolymer composition of claim 3, wherein the organic functional group is selected from the group consisting of a sulfonic acid, an acrylic/methacrylic acid, an amide, a pyrrolidone, and ethylene glycol organic functional group.

5. The organic-inorganic hybrid photopolymer composition of claim 3, wherein the inorganic nanoparticle comprising an inorganic functional group on the surface of the nanoparticle is selected from the group consisting of silica, titanium dioxide, zirconia, aluminum oxide, magnesium oxide, magnesium hydroxide and antimony pentoxide.

6. The organic-inorganic hybrid photopolymer composition of claim 5, wherein the inorganic nanoparticle is silica or titanium dioxide

7. The organic-inorganic hybrid photopolymer composition of claim 1, wherein the photopolymerizable monomer is selected from the group consisting of acrylamide, bisacrylamide, t-butylacrylamide, vinyl carbazole, alkyl acrylate, multifunctional alkyl acrylate, a benzyl acrylate, a multifunctional benzyl acrylate series, stylene, acrylonitrile, vinyl imidazole, vinyl cycloprophane, and combinations thereof.

8. The organic-inorganic hybrid photopolymer composition of claim 1, wherein the photoinitiator is selected from the group consisting of triethanolamine, butyle amine, triethylamine, N-phenylglycine, sulfinates, enolates, carboxylates, p-toluene sodium salt, acetylacetone, t-butyl hydrogen peroxide, ferric ammonium citrate, hexaarylbiimidazole, aromatic carbonyl compound, ketone derivatives and quinone derivatives.

9. The organic-inorganic hybrid photopolymer composition of claim 1, wherein the photosensitizer is selected from the group consisting of methylene blue, yellowiosine, tionin, Rose Bengal, Erythrosin B and acryflavine.

10. The organic-inorganic hybrid photopolymer composition of claim 1, wherein the nanoparticle has a diameter of about 10 nm to about 70 nm.

11. A method of making a organic-inorganic hybrid photopolymer comprising (a) mixing a polymethylmethacrylate copolymer matrix, an acrylamide photopolymerizable monomer, a hydrophilic inorganic silica nanoparticle, an initiator, and a sensitizer to form a mixture, and (b) polymerizing the mixture.
